(19) United States
(12) Patent Application Publication
(10) Pub. No.: US 2005/0008174 A1
(43) Pub. Date: Jan. 13, 2005

(54) Underwater sound source

(75) Inventor: Arto Laine, Tampere (FI)

Correspondence Address: Ladas & Parry, 26 West 61 Street, New York, NY, 10023, US

(73) Assignee: PATRIA ADVANCED SOLUTIONS OY

(21) Appl. No.: 10/868,507

(22) Filed: Jun. 14, 2004

(30) Foreign Application Priority Data
Jun. 18, 2003 (FI) 20030918

(51) Int. Cl. H04R 25/00

(52) U.S. Cl. 381/162; 381/163

(57) ABSTRACT

A sound source comprising an actuator element (1) that vibrates in a reciprocating manner such that the distance between the ends of the actuator element (1) varies. To the ends of the actuator element (1) there is attached a spring element (3) that moves by the action of the actuator element. In lateral view the spring element (3) is substantially rectangular. The ends (3a) of the spring element rectangle are elastic and so are the sides (3b) of the rectangle. The ends (3a) and the sides (3b) are joined together by substantially rigid corners (3c).

### FIELD OF THE INVENTION

The invention relates to an underwater sound source comprising an actuator element that vibrates in a reciprocating manner, whereby the distance between the ends of the actuator element varies, and a spring element that is secured to the ends of the actuator element, whereby the spring element moves by the action of the actuator element.

### BACKGROUND OF THE INVENTION

Regarding underwater sound sources, there is known a structure, which comprises an actuator, such as a piezoceramic actuator or a magnetostrictive actuator, that vibrates in a reciprocating manner, whereby the distance between the actuator ends varies. To the ends of the actuator there is secured a spring element moving by the action of the actuator. The spring element is typically elliptic in shape as set forth in U.S. Pat. No. 5,497,357. When the oscillation frequency of the actuator reaches a so-called natural/resonance frequency, the structures of the sound source resonate such that the motion generated by the sound source is relatively large. Further, immediately after the resonance frequency follows so-called anti-resonance, in which the motion generated by the sound source is in turn considerably reduced. So, the effect of resonance and anti-resonance on the magnitude/dimensions of the motion should be reduced.

EP publication 0 475 343 discloses a sound source which also comprises an actuator that vibrates in a reciprocating manner and a spring element attached to the ends thereof. The sides of the spring element are concave, i.e. they curve inwardly. This solution poses problems similar to those in the elliptic structure.

### BRIEF DESCRIPTION OF THE INVENTION

The object of the present invention is to provide a novel underwater sound source.

The method of the invention is characterized in that in lateral view the spring element is substantially rectangular, that ends of the spring element are elastic, that sides of the spring element are elastic and that the ends and the sides are joined together by substantially rigid corners.

The basic idea of the invention is that a sound source comprises an actuator that vibrates in a reciprocating manner such that the distance between the actuator element ends varies. To the ends of the actuator element there is attached a spring element, which moves by the action of the actuator element. In lateral view the spring element is substantially rectangular. The ends of spring element rectangle are elastic and so are the sides of the rectangle. The ends and the sides of the rectangle are joined together by substantially rigid corners. This structure provides a considerable reduction in the effect of the resonance frequency of the sound source and the anti-resonance after the resonance on the motion of the actuator element. The basic idea of one embodiment is that the spring element is arranged to vibrate such that the shape of the spring element sides varies between concave and convex. In addition, thanks to the joined, vibrating ends and sides a low-frequency sound source can be made smaller in size. Further, the structure of the spring element is simple and relatively easy to manufacture. The rectangular shape of the spring element is also advantageous for the placement of an actuator element that is rectangular in lateral view. The wall structure of the spring element may be of uniform thickness, or in accordance with one embodiment, the structure of the spring element wall is provided with areas that bend more easily. The areas that bend more easily can be provided by thinning the walls, for instance. The areas that bend more easily can be provided in the ends or sides, or both, of the spring element.

### BRIEF DESCRIPTION OF THE DRAWINGS

The invention will be described in greater detail in connection with the attached drawings, wherein

FIG. 1 is a schematic side view of an underwater sound source;

FIG. 2 is a schematic side view of a second underwater sound source; and

FIG. 3 is a schematic side view of a third underwater sound source.

### DETAILED DESCRIPTION OF THE INVENTION

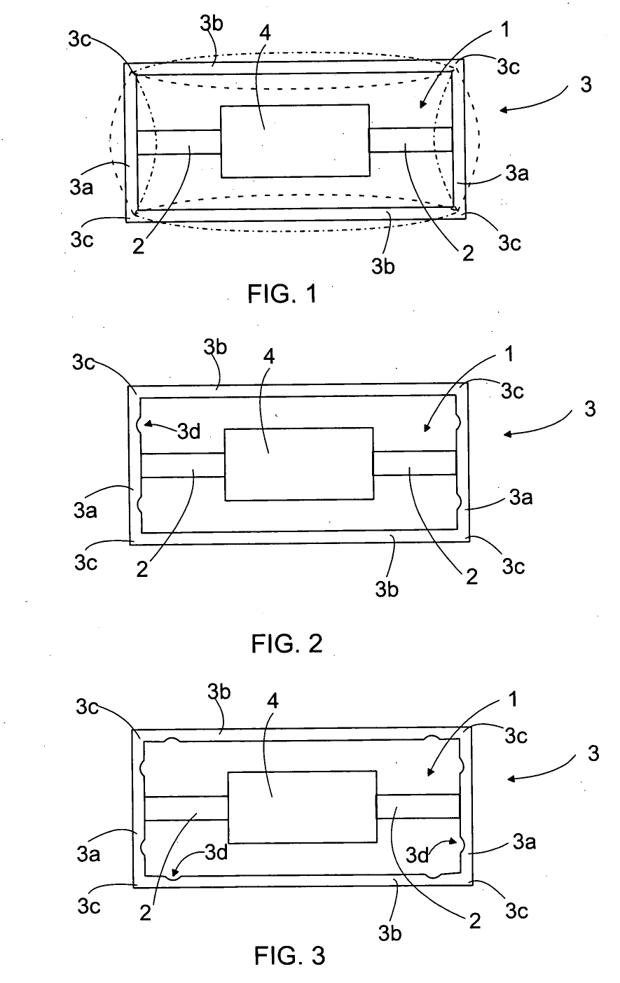

FIG. 1 shows an underwater sound source comprising an actuator element 1. The actuator element 1 can be a piezoceramic or magnetostrictive actuator, for instance. The actuator element 1 may consist of rods 2, such as magnetostrictive rods or piezoelectric rods, which are made of a suitable material. When necessary, the rod 2 can be divided into a plurality of shorter parts and there may be a plurality of rods in parallel. The actuator element 1 comprises means for controlling an electric or magnetic field to affect the rod 2 such that the rod becomes shorter or longer in the longitudinal direction, i.e. the distance between the ends of the actuator element 1 varies, in other words the actuator element 1 oscillates. The means for controlling the actuator element 1 are known per se to the person skilled in the art, and thus, for the sake of clarity, they are not shown in the attached drawing.

To the ends of the actuator there is attached a spring element 3 having an orthogonal, i.e. rectangular shape in lateral view. The rods of the actuator element 1 are attached at their ends to the spring element ends 3a. The spring element ends 3a are joined to the spring element sides 3b by substantially rigid corners 3c. The spring element ends 3a are elastic and so are the spring element sides 3b. The elasticity of the ends 3a and the sides 3b and the rigidity of the corners 3c effect that as the actuator element 1 gets longer, the spring element 3 takes the shape as indicated by a broken line in FIG. 3. Thus the spring element ends 3a curve outwardly and the spring element sides 3b curve inwardly. As the actuator element 1 gets shorter, the ends 3a and the sides 3b take the shape as indicated by a dash-and-dot line in FIG. 1. Thus the spring element ends 3a curve inwardly and the spring element sides 3b curve outwardly. Further, the operating principle is typical only at a first resonance frequency and therebelow. At frequencies higher than that the behaviour changes: the phase shift between the sides becomes indeterminate and free vibration of a higher order is produced in the sides.

The material and the dimensions of the spring element 3 determine resonance frequencies and a useable frequency range for a transmitter. The spring element wall must be sufficiently thick in order that the first resonance of the spring element 3 would be clean and it would be close to the lower limit frequency of the sound source. The spring element 3 can be made of metal, for instance, but most advantageously the spring element 3 is made of a plastic composite, such as carbon fibre or glass fibre, whereby the resonances will be lower due to high loss modulus of the material. The length of the longer side, i.e. side 3b, of the spring element may be within the range of 4 to 150 cm, for instance. The ratio of the shorter side, i.e. side 3a, to the longer side is advantageously about 1 to 2. The ratio of the thickness of the wall to the longer side in the spring element 3 may be between 1 to 30 and 1 to 50, for instance, depending on the elastic modulus of the material. Correspondingly, the ratio of the width to the longer side in the spring element 3 is most advantageously between 1 to 2 and 1 to 1.

The rods 2 of the actuator element are attached to a support element 4, which in turn is secured in a fixed manner to the body of a sound transmitter. For the sake of clarity, the body of the sound transmitter is not shown in the attached drawings.

Thus, as the sound source operates its shape changes from a rectangle to shapes in accordance with those denoted by a broken line and a dash-and-dot line and the shapes between those two. In the spring element 3 the ends 3a and the sides 3b are surfaces that vibrate differently and that are separated by the corners 3c to form separate wholes.

FIG. 2 shows a sound source, in which the ends 3a of the spring element 3 are provided with areas which bend more easily than others. The easily bending areas are provided by making recesses 3d in the spring element wall. The easily bending areas are so-called hinge points, by which the elasticity of the ends 3a can be improved.

In FIG. 3, easily bending areas are also formed in the sides 3b of the spring element. Also in this case the easily bending areas are provided by making recesses 3d in the spring element wall. Naturally, the easily bending areas can also be provided by modifying the properties of the material, for instance, without changing the thickness thereof.

Most advantageously the spring element vibrates, for instance for the sides 3b, to achieve both a convex and a concave shape, i.e. on both sides of the rectangular shape. Hence, the vibration will be relatively symmetrical. However, it is possible to produce the spring element 3 such that the spring element 3 is first made rectangular and then by means of the actuator element 1 it is tensioned such that the sides 3b are curved inwardly. In that case the spring element 1 will not necessarily vibrate in such a manner that the sides 3 would curve outwardly. Further, it is possible to provide the spring element 1 such that the sides 3 are first curved outwardly and by means of the actuator element the spring element is pre-tensioned into an orthogonal shape.

The drawing and the relating description are only intended to illustrate the inventive idea. The details of the invention may vary within the scope of the claims. So, the sound source may be provided with a casing and its structure may be reinforced in a desired manner.

1. An underwater sound source comprising an actuator element that vibrates in a reciprocating manner, whereby the distance between the ends of the actuator element varies, and a spring element that is attached to the ends of the actuator element, whereby the spring element moves by the action of the actuator element, wherein in lateral view the spring element is substantially rectangular, ends of the spring element are elastic, sides of the spring element are elastic and the ends and the sides are joined together by substantially rigid corners.

2. A sound source as claimed in claim 1, wherein the spring element is arranged to vibrate such that the shape of the sides in the spring element varies between concave and convex.

3. A sound source as claimed in claim 1, wherein the ends and/or the sides of the spring element are provided with areas which bend more easily than others.

4. A sound source as claimed in claim 3, wherein the easily bending area is provided by making a recess in the wall of the spring element.

5. A sound source as claimed in claim 2, wherein the ends and/or the sides of the spring element are provided with areas which bend more easily than others.
